(19) United States
(12) Patent Application Publication
(10) Pub. No.: US 2026/0122491 A1
(43) Pub. Date: Apr. 30, 2026

(54) SECURE, PRIVATE AND SEAMLESS PASSCODE FORWARDING IN MOBILE DEVICES

(71) Applicant: WhatsApp LLC, Menlo Park, CA (US)

(72) Inventors: Bharath Kumar Avva Ramamurthy, San Jose, CA (US); Lucas Frossard, Vancouver (CA); Nitin Asokan, San Jose, CA (US)

(21) Appl. No.: 18/927,761

(22) Filed: Oct. 25, 2024

(51) Int. Cl. H04W 12/06; H04W 4/12; H04W 12/03

(52) U.S. Cl. CPC H04W 12/068; H04W 4/12; H04W 12/03

(57) ABSTRACT

A mobile device of the subject technology includes a network interface to facilitate communication with a first server and a second server, a business application to communicate with the first server via the network interface, and a messaging application to communicate with the second server via the network interface. The business application is used to leverage the first server to send an encrypted message including metadata to the second server, and the messaging application is used further to receive, from the second server, a one-time code (OTP) message along with the metadata. The subject technology includes a seamless, verified, secure and private transfer, without user interaction, of the OTP from WhatsApp app to the business app in the device in a secure and private manner.

### BACKGROUND

### Technical Field

The present disclosure is related generally to mobile devices, and more specifically, to a secure, private and seamless passcode forwarding in mobile devices.

### Related Art

Messaging applications such as WhatsApp can be used by businesses for commercial uses. For example, a business can use the messaging application for marketing use by creating a profile and uploading a product catalog, and other information to engage with customers, for instance, in one-on-one chats. The business can use a business platform or a business application to create a business account with a messaging application (e.g., WhatsApp) to avoid limitations of non-business messaging applications.

The automatic messaging verification method uses a messaging retriever application-program interface (API) to perform user verification automatically without requiring the user to manually type verification codes, and without requiring any extra application permissions. The user initiates the verification process in an application, which requests a server to verify the user's phone number and at the same time calls a messaging retrieval API for listening for messaging response from the server. The user receives, from the server, a message that includes a one-time passcode (OTP) to be sent back to the server, an application identifier (e.g., package name) and an application hash that verifies the application. The application identifier is used to identify the application that would receive the code. The application hash is used to verify the authenticity of the application that would receive the code, and the OTP code is made available to the application through the messaging retriever API. The OTP code is sent back to the business server. It is noted that OTP is also used to refer to one-time password/passcode and, in some occasions, one-time code (OTC) is used instead of OTP.

### SUMMARY

An aspect of the subject technology is directed to a mobile device that includes a network interface to facilitate communication with a first server and a second server, a business application to communicate with the first server via the network interface, and a messaging application to communicate with the second server via the network interface. The business application is used to leverage the first server to send an encrypted message including metadata to the second server, and the messaging application is used further to receive, from the second server, an OTP message along with the metadata.

Another aspect of the disclosure is related to a method including receiving, by a business server, a request for authentication of a phone number associated with a mobile device of a user and generating a first code associated with the phone number and storing the first code. The method further includes instructing a messaging API to send an authentication message including the first code and a template to the phone number and the business application receiving, from the messaging app which received the message, a request for authentication of the phone number with a second code. The method further includes informing a business application of the mobile device of a successful authentication after confirming that the second code matches the stored first code.

Yet another aspect of the disclosure is related to a method including receiving, by a messaging application installed on a mobile device, a request for sending an authentication message/code to another application installed/available on the mobile device along with an application identifier, an OTP and a first application hash configured on a template. The method further includes checking an application hash match by recomputing an application hash of the private information that the underlying OS used for the application and comparing with the first application hash to verify a business application on the device with the application identifier is authentic, checking zero-tap and one-tap eligibility based on one-tap conditions, and checking that a request for listening has been received from the business application.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a network environment within which aspects of the subject technology are implemented.

FIG. 2 is a flow diagram illustrating an example algorithm for implementing a secure, private and seamless passcode forwarding in mobile devices, according to some aspects of the subject technology.

FIG. 3 is a sequence diagram illustrating an example event sequence for implementing a secure, private and seamless passcode forwarding in mobile devices, according to some aspects of the subject technology.

FIG. 4 is a flow diagram illustrating a method of implementing a secure, private and seamless passcode forwarding in mobile devices, according to some aspects of the subject technology.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

According to some aspects, the subject technology is directed to a secure, private and seamless passcode forwarding in mobile devices of a user. The mobile device can be, but is not limited to, a smart phone, a smartwatch, a tablet, a laptop, a desktop, a browser, a virtual machine or other mobile devices. In the context of the present disclosure, the user is a client or a customer of a business entity (hereinafter, business), which is using a messaging application for sending business messages including marketing materials or other promotional or informational messages to the user or receiving messages from the user. The messages received from the user may include orders for products or services that the business provides, feedback from the user, or other user messages. The messaging application can be, but is not limited to, WhatsApp, Messenger, or other messaging applications. The business has a business application that the user can download. Therefore, for the purposes of the subject disclosure, both the business application and the messaging application are installed/available on the same mobile device of the user.

The Businesses have to configure a message template on a messaging application manager such as the WhatsApp manager. The message template includes an application identifier (e.g., Android package name), an application hash, and an optional timeout. The businesses, along with sending the name of the template that contains the application identifier and application signature, also send a passcode separately in metadata (along with embedding it in the message) for use by the messaging application to be shared with the business. The application requesting the passcode signals the messaging application, by using a communication mechanism (e.g., Android Intent), indicating that a message in the next few minutes is expected. This signal also has a request ID. The messaging application uses the signal to store the application identifier of the requestor and the request ID. The application requesting the code triggers a request to the business server that in turn triggers a send-message application-program interface (API) on the messaging API, providing the template ID and passcode. The messaging API sends the message to the messaging application. The message includes the application identifier and the application hash included in the template. The messaging application, upon receiving the message, extracts message template information such as the application identifier, the signature and the timeout and validates the information. The validation includes checking whether there is a signal for that business application identified by that application identifier, whether the signature received in the message matches the one of the business applications, and whether the request has not timed out. If the information is validated, the messaging application forwards the passcode to the business application by using the same or different communication mechanism (e.g., Android Intent).

The disclosed solution allows business partners to provide a seamless experience to their users whenever they need to validate user authenticity by sending them OTPs when the business application is available on the same device. This feature has proven to increase user conversion by about 13% and improves time to conversion as well. A conversion rate records the percentage of users who have completed a desired action. Conversion rates are calculated by taking the total number of users who convert (for example, by clicking on an advertisement), dividing it by the overall size of the audience and converting that figure into a percentage.

The disclosed solution also provides competitive advantage to the messaging application. As more businesses are integrated with the messaging application, the value delivered by the messaging application will increase. This further causes an increase in user perception of the value provided by the messaging application.

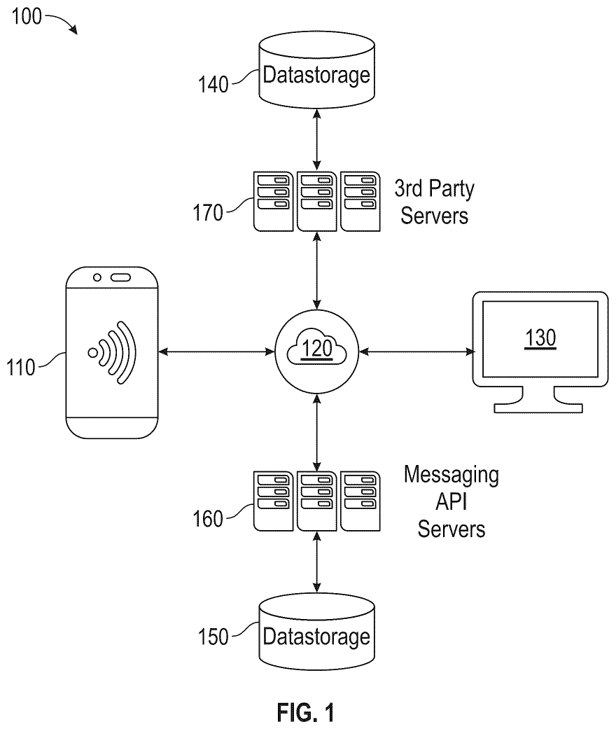

Now turning to the description of figures, FIG. 1 is a schematic diagram illustrating an example of a network environment 100 within which aspects of the subject technology are implemented. The network environment 100 includes, but is not limited to, a mobile device 110 (e.g., a smartphone, a tablet, a laptop or other mobile devices) handled by a user, a network 120, computer 130, a cloud datastorage 140, a datastorage 150, third party servers 170 and messaging API servers 160 The mobile device 110, the cloud datastorage 140 and the datastorage 150 may exchange commands, instructions, and data through the network 120. The mobile device 110 can be used by a customer of a business to engage with a messaging application (e.g., WhatsApp) of a business, for example, to order a product of the business, enter a phone number, request a call back, chat with an agent of the business, enter an address, request delivery of the product to the address, etc. The remote server 170 may be a server of the business that has advertised on the messaging application with the intention of engaging in a one-on-one chat with customers. The network 120 may include, for example, any one or more of a local area network (LAN), a wide area network (WAN), the Internet, and the like. Further, the network 120 can include, but is not limited to, any one or more of the following network topologies, including a bus network, a star network, a ring network, a mesh network, a star-bus network, tree or hierarchical network, and the like.

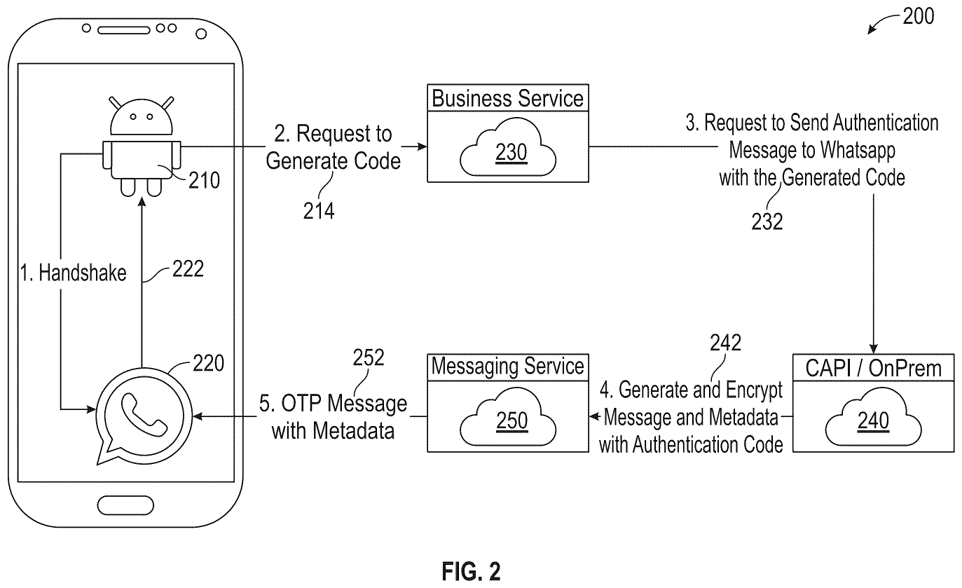

FIG. 2 is a flow diagram illustrating an example algorithm 200 for implementing a secure, private, and seamless passcode forwarding in mobile devices, according to some aspects of the subject technology. The algorithm 200 depicts the flow of messages and codes between a business application 210, a messaging application 220, a business server 230, a common API (CAPI) 240 and a messaging server 250. The business application 210 is an application supported by the business and is installed on a mobile device of a user. The messaging application 220 (e.g., WhatsApp), also installed on the user mobile device, is used by the business to communicate business messages including marketing materials or other promotional or informational messages to the user or receiving messages from the user. The messages received from the user may include orders for products or services that the business provides, feedback from the user, or other user messages. The PI 240 exists on the messaging server 250 or another server associated with the messaging server 250.

The algorithm 200 starts with step 1, where a handshake process 212 is initiated by the business application 210 with the messaging application 220, during which the business application 210 informs the messaging application 220 that it expects an OTP. Following the handshake process 212, in step 2, the business application 210 sends a request 214 to the business server 230 (e.g., a cloud server), which is a server used by the business. In some embodiments, the handshake process 212 can happen before, at the time or soon after the business application 210 sends a request 214 to the business server 230. In response to the request 214, in step 3, the business server 230 generates and sends a code 232 to the API 240. In step 4, the API 240, based on the received code 232, generates and encrypts a message and metadata 242, which is sent to the messaging server 250 (e.g., WhatsApp server). In step 5, the messaging server 250 generates an OTP message 252 including the metadata to the messaging application 220. Finally, in step 6, the messaging application 220 retrieves an OTP 222 from the metadata and sends the OTP 222 to the business application 210. The algorithm 200 facilitates authentication of the user without the user involvement.

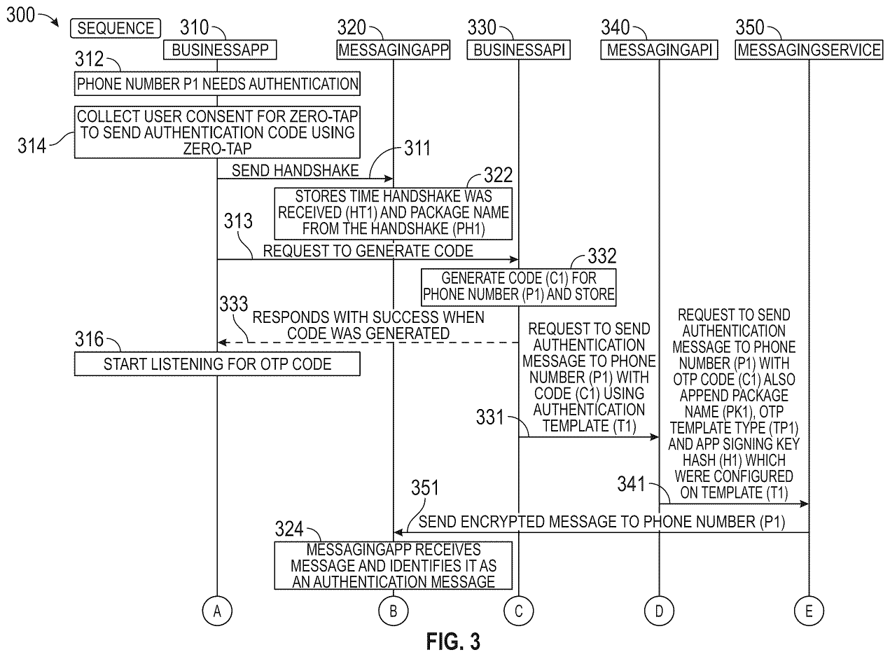

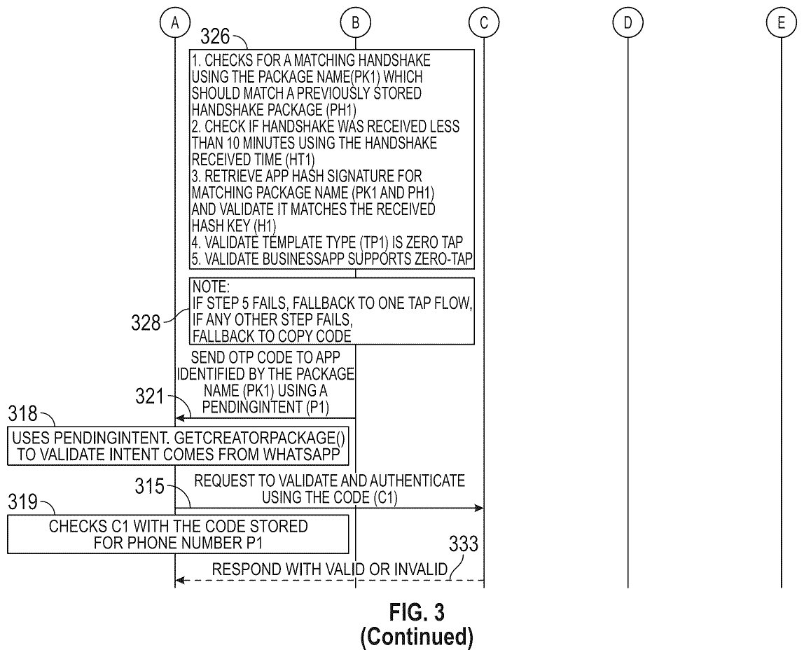

FIG. 3 is a sequence diagram illustrating an example event sequence 300 for implementing a secure, private and seamless passcode forwarding in mobile devices, according to some aspects of the subject technology. The event sequence 300 depicts several communications between and steps taken by, a business App 310 a messaging App 320, a business API 330, a messaging API 340 and messaging service 350.

Initially, the business APP 310, at operation block 312, prepares for authentication of phone number pl. Next, the business APP 310, at operation block 314, collects user consent for zero-tap to send authentication code using zero-tap and then sends a handshake message 311 to the messaging App 320. The messaging App 320, at operation block 322, stores the time the handshake was received (HT1) and application identifier (PH1) from the handshake message 311. Next, the business APP 310 sends a message 313 to the business API 330 to request that a code (an OTP) be generated. The business API 330, at operation block 332, generates code (C1) for the phone number (P1) and stores it. The business API 330 may respond to the business App 310 by a message 333 to confirm that the code was generated. The business App 310, at operation block 316 starts listening for the OTP code. Subsequently, the business API 330 sends a message 331 to messaging API 340 requesting that an authentication message be sent to the phone number (P1) with the code (C1) using an authentication template (T1). In response, the messaging API 340 sends a request 341 to the messaging service 350 asking to send an authentication message to the phone number (P1) with an OTP code (C1) and also append application identifier (P1), OTP template type (TP1) and App signing key application hash (H1), which were configured on the template (T1).

The messaging service 350, in response, sends an encrypted message 351 to the messaging App 320 linked to the phone number (P1). The messaging App 320, in operation block 324, receives the message and identifies the message as an authentication message. Then, the messaging App 320, in operation block 326, performs the following steps. 1) Checks for a matching handshake using the application identifier (PK1), which should match a previously stored handshake package (PH1). 2) Checks if the handshake was received in less than 10 minutes using the handshake received time (HT1). 3) Retrieves application hash signature for matching application identifier (PK1, PH1) and validates that it matches the received application hash key (H1). 4) and validates that template type (TP1) is zero-tap. 5) Validates that the business App 310 supports zero-tap flow. Next, if the validation in step 5 failed, at operation block 328, the messaging App 320 falls back to one-tap flow. And if any other steps fails, falls back to the copy code. If no validation fails, then, the messaging App 320 send a message 321 to the Business App 310 using a pending intent (PI1), the message 321 includes the OTP code to the app identified by the application identifier (PK1).

In response, the business App 310, at operation block 318, verifies the application identifier to validate that intent comes from WhatsApp. Then the business App 310 sends a request 315 to validate and authenticate using the code (C1) to the business API 320. The business App 310, in operation block 319, checks C1 with the code stored for the phone number (P1). Next, the business App 310 may receive a response to the request 315 from the business API 320 indicating whether the code (C1) is valid or not.

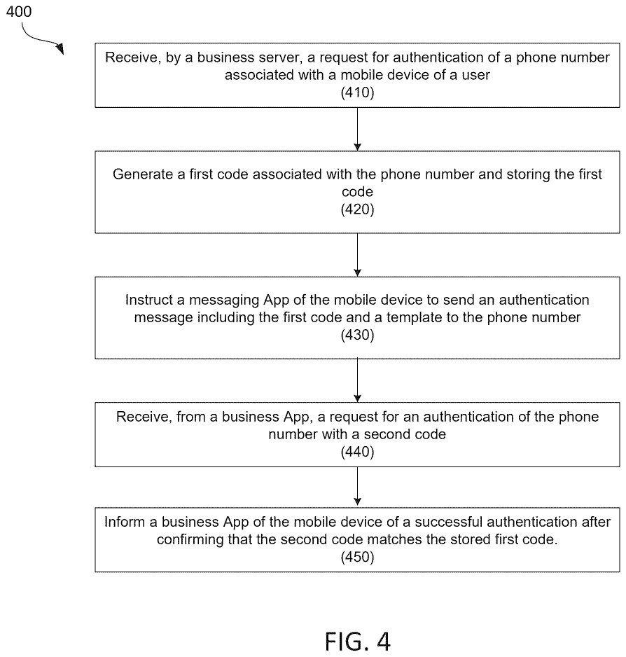

FIG. 4 is a flow diagram illustrating a method 400 of implementing a secure, private and seamless passcode forwarding in mobile devices, according to some aspects of the subject technology. In some embodiments, at least one step in the method 400 may be executed by a processor subsystem (e.g., 220 of FIG. 2) reading instructions from a memory subsystem (e.g., 230 of FIG. 2). The processor subsystem and the memory subsystem may be in a mobile device (e.g., 110 of FIG. 1), a server (e.g., 130 of FIG. 1), or a cloud server, as disclosed herein.

In some embodiments, methods consistent with the present disclosure may include at least one or more of the steps in method 400 performed in a different order, simultaneously, quasi-simultaneously, or overlapping in time.

The method 400 includes process steps 410, 420, 430, 440 and 450. In the process step 410, a business server receives a request for authentication of a phone number associated with a mobile device of a user and generates a first code associated with the phone number and stores the first code.

In the process step 420, a first code associated with the phone number is generated and stored.

In the process step 430, a messaging application of the mobile device is instructed to send an authentication message including the first code and a template to the phone number.

In the process step 440, a request for an authentication of the phone number with a second code is received by a business application.

In the process step 450, a business application of the mobile device is informed of a successful authentication after confirming that the second code matches the stored first code.

An aspect of the subject technology is directed to a mobile device that includes a network interface to facilitate communication with a first server and a second server, a business application to communicate with the first server via the network interface, and a messaging application to communicate with the second server via the network interface. The business application is used to leverage the first server to send an encrypted message including metadata to the second server, and the messaging application is used further to receive, from the second server, an OTP message along with the metadata.

In some aspects, the messaging application is further configured to retrieve the OTP from the metadata and send the retrieved OTP to the business application.

In one or more aspects, the metadata is generated by an application program interface (API) associated with the second server.

In some aspects, the metadata is produced by the API based on a code generated by the first server.

In one or more aspects, the messaging application is further configured to receive, from the API, a template including an application identifier, an application hash and an optional time-out.

In some aspects, the messaging application is further configured to retrieve information from the template and validate the information including the application identifier, the application hash and the time-out.

In one or more aspects, the messaging application is further configured to validate the information by checking whether there is a signal for the business application identified by the application identifier, whether the application hash matches a signature of the business application, and whether the timeout has expired.

In some aspects, the business application is further configured to inform the messaging application, during an initial handshake, of an expectation of receiving the OTP from the messaging application.

In one or more aspects, the messaging application is used by a business entity to communicate with a user.

In some aspects, the user is a client or a customer of the business entity and uses the messaging application to receive messages from the business entity or send request or feedback messages to the business entity.

Another aspect of the disclosure is related to a method including receiving, by a business server, a request for authentication of a phone number associated with a mobile device of a user and generating a first code associated with the phone number and storing the first code. The method further includes instructing a messaging application of the mobile device to send an authentication message including the first code and a template to the phone number and receiving, from a business application, a request for an authentication of the phone number with a second code. The method further includes informing a business application of the mobile device of a successful authentication after confirming that the second code matches the stored first code.

In some aspects, the user is a client or a customer of a business entity, wherein the messaging application is used by the business entity to establish business communications with the user.

In one or more aspects, the business application is supported by the business entity to facilitate for the user to have business interactions with the business entity.

In some aspects, receiving the request for authentication follows a confirmation by the business application that the second code had been received from the messaging application of the mobile device.

In one or more aspects, the confirmation by the business application follows receiving from the messaging application the second code, and an application identifier included in the template along with a null intent.

In some aspects, receiving the application identifier and the null intent follows confirming at least two conditions including a match success of a signing application hash received from a messaging application API and the application identifier being included in a list of approved application identifiers.

Yet another aspect of the disclosure is related to a method including receiving, by a messaging application installed on a mobile device, a request for sending an authentication message to a phone number associated with the mobile device along with an application identifier, a one-time code (OTP) and a first application hash configured on a template. The method further includes checking an application hash match by validating the application hash for the given application identifier and comparing with the first application hash—received on the message metadata-to verify a business application on the mobile device with the application identifier is authentic, checking zero-tap and one-tap eligibility based on one-tap conditions (i.e, and checking that a request for listening has been received from the business application.

In some aspects, the method further includes checking whether the template is a zero-tap authentication template, and wherein the one-tap conditions include a consent for listening for a code by the business application and a successful application hash match.

In one or more aspects, the method further includes sending, by the messaging application, a message to the business application, the message including the OTP and the application identifier along with a null pending intent.

In some aspects, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A mobile device, comprising:
a network interface configured to facilitate communication with a first server and a second server;
a business application configured to communicate with the first server via the network interface; and
a messaging application configured to communicate with the second server via the network interface,
wherein:
the business application is further configured to leverage the first server to send an encrypted message including metadata to the second server; and
the messaging application is further configured to receive, from the second server, a one-time code (OTP) message along with the metadata.

2. The mobile device of claim 1, wherein the messaging application is further configured to retrieve the OTP from the metadata and send the retrieved OTP to the business application.

3. The mobile device of claim 1, wherein the metadata is generated by an application program interface (API) associated with the second server.

4. The mobile device of claim 3, wherein the metadata is produced by the API based on a code generated by the first server.

5. The mobile device of claim 4, wherein the messaging application is further configured to receive, from the API, a template including an application identifier, an application hash and a time-out.

6. The mobile device of claim 5, wherein the messaging application is further configured to retrieve information from the template and validate the information including the application identifier, the application hash and the time-out.

7. The mobile device of claim 6, wherein the messaging application is further configured to validate the information by checking whether there is a signal for the business application identified by the application identifier, whether the application hash matches a signature of the business application, and whether the timeout has expired.

8. The mobile device of claim 1, wherein the business application is further configured to inform the messaging application, during an initial handshake, of an expectation of receiving the OTP from the messaging application.

9. The mobile device of claim 1, wherein the messaging application is used by a business entity to communicate with a user.

10. The mobile device of claim 9, wherein the user is a client or a customer of the business entity and uses the messaging application to receive messages from the business entity or send request or feedback messages to the business entity.

11. The mobile device of claim 9, wherein the messaging application is configured to receive a message template.

12. A method, comprising:
receiving, by a business server, a request for authentication of a phone number associated with a mobile device of a user;
generating a first code associated with the phone number and storing the first code;
instructing a messaging application of the mobile device to send an authentication message including the first code and a template to the phone number;
receiving, from a business application, a request for an authentication of the phone number with a second code; and
informing a business application of the mobile device of a successful authentication after confirming that the second code matches the stored first code.

13. The method of claim 12, wherein the user is a client or a customer of a business entity, and wherein the messaging application is used by the business entity to establish business communications with the user.

14. The method of claim 13, wherein the business application is supported by the business entity to facilitate for the user to have business interactions with the business entity.

15. The method of claim 14, wherein receiving the request for authentication follows a confirmation by the business application that the second code had been received from the messaging application of the mobile device.

16. The method of claim 15, wherein the confirmation by the business application follows receiving, from the messaging application the second code, and an application identifier included in the template along with a null intent.

17. The method of claim 16, wherein receiving the application identifier and the null intent follows confirming at least two conditions including a match success of a signing application hash received from a messaging application API and the application identifier being included in a list of approved application identifiers.

18. A method comprising:
receiving, by a messaging application installed on a mobile device, a request for sending an authentication message to a phone number associated with the mobile device along with an application identifier, a one-time code (OTP) and a first application hash configured on a template;
checking an application hash match by recomputing an application hash for the application identifier and comparing with the first application hash to verify a business application on the mobile device with the application identifier is authentic;
checking zero-tap and one-tap eligibility based on one-tap conditions; and
checking that a request for listening has been received from the business application.

19. The method of claim 18, further comprising checking whether the template is a zero-tap authentication template, and wherein the one-tap conditions include a consent for listening for a code by the business application and a successful application hash match.

20. The method of claim 18, further comprising sending, by the messaging application, a message to the business application, the message including the OTP and the application identifier along with a null pending intent.
